(19) United States
(12) Patent Application Publication
(10) Pub. No.: US 2020/0198304 A1
(43) Pub. Date: Jun. 25, 2020

(54) MULTILAYER STRUCTURE FOR THE CREATION OF A MULTIPURPOSE SPORTS FLOORING

(71) Applicant: Gerflor, Villeurbanne (FR)

(72) Inventors: Pierrick PAILLOT, Saint Etienne (FR); Bastien PUECH, Montrottier (FR)

(73) Assignee: Gerflor, Villeurbanne (FR)

(21) Appl. No.: 16/608,831

(22) PCT Filed: Apr. 25, 2018
(86) PCT No.: PCT/EP2018/060558

§ 371 Date: Oct. 27, 2019

(30) Foreign Application Priority Data
Apr. 27, 2017 (FR) 1753660

(51) Int. Cl. B32B 27/06; B32B 27/30; B32B 27/08; B32B 27/22; B32B 5/18; B32B 5/02; B32B 5/24; B32B 27/36; B32B 27/12; E04F 15/22; E04F 15/18

(52) U.S. Cl. CPC B32B 27/065; B32B 2471/00; B32B 27/08; B32B 27/22; B32B 5/18; B32B 5/022; B32B 5/245; B32B 27/36; B32B 5/028; B32B 27/12; E04F 15/22; E04F 15/18; B32B 2307/412; B32B 2266/0235; B32B 2262/0276; B32B 2262/101; B32B 2307/56; B32B 27/304

(57) ABSTRACT

The invention relates to a multilayer for the creation of a multipurpose sports flooring, said multilayer structure (1) comprising an upper wear layer composed of at least one surface layer (4), the wear layer (2) being attached to a backing layer (3) made of polyvinyl chloride foam. According to the invention, the multilayer structure (1) comprises a polymer film (5), positioned between the surface layer (4) and the backing layer (3), and having a stiffness of greater than 100 N/mm and a Young's modulus of greater than 1.5 GPa.

### TECHNICAL FIELD

The present invention relates to a multilayer structure for the creation of a so-called “sports” floor covering, i.e. intended for sports halls, fitness rooms, multipurpose gyms, and the like.

### PRIOR ART

A multilayer structure for the creation of a sports floor covering is known from the state of the art. A sports floor covering must allow for ensuring the safety and protection of the user, in particular in terms of absorption of occasional shocks. In particular, an occasional sports floor covering must meet the NF EN 14904 standard of June 2006, according to which the floor covering must absorb 25% of shocks.

It is for this reason that a sports floor covering has a multilayer structure generally comprising an upper wear layer, the main functions of which are slip control, resistance to wear, ease of cleaning and the decorative aspect, attached to a reverse layer made of polyvinyl chloride foam having a density of generally between 0.30 and 0.40 and a thickness of between 4 and 7 mm, enabling absorption of occasional shocks.

This type of sports floor covering provides full user satisfaction with regards to safety and protection. However, in practice, this type of floor covering is often laid in so-called multipurpose gyms, i.e. that are able to host non-sporting events which may damage the floor covering.

Indeed, the reverse foam can be subjected to traffic, heavy loads or unanticipated impacts that can dent and damage the floor covering. Indeed, if the sports floor covering is excellent to absorb occasional shocks, it is less suitable for withstanding the aforementioned stresses.

To resolve this problem, it is common practice to integrate in the multilayer design of the sports floor covering at least one reinforcement mesh integrated in the wear layer, and even to complex the polyvinyl chloride foam with an additional mesh. The use of these meshes allows reinforcing the multilayer structure in terms of dimensional stability and resistance to traffic. However, this solution is too expensive and complex to implement and does not significantly increase the resistance to indentation.

Another drawback is the fact that a reinforcement mesh, such as a glass mesh, whether complexed or not to a non-woven fabric support, tends to irreversibly deform, and even break, under the load which reduces the useful life of the floor covering.

### BRIEF DESCRIPTION OF THE INVENTION

Therefore, one of the aims of the invention is to propose a multilayer structure for the creation of a multipurpose sports floor covering, i.e. enabling at least 25% of occasional shocks to be absorbed, while resisting to traffic, heavy loads and impacts, and in particular being able to meet the indentation requirement defined by the NF EN 14904 standard of June 2006, which provides for residual deformation measured according to the NF EN 1516 standard of October 1999 of less than 0.5 mm.

Another aim of the present invention is to provide such a floor covering that is capable of resisting punching with a residual deformation measured according to the NF EN 1516 standard of October 1999 of less than 0.1 mm.

To do so, a multilayer structure is proposed for the creation of a sports floor covering in line with that of the state of the art, in that it comprises an upper wear layer composed of at least one surface layer, attached to a reverse layer made of polyvinyl chloride foam.

According to the invention, the multilayer structure comprises a polymer film, positioned between the surface layer and the foam reverse layer, and having a stiffness of greater than 100 N/mm and a Young's modulus of greater than 1.5 GPa, in order to limit indentation phenomena in the foam by enabling a better stress distribution and a reduction in the shearing effect on the cell walls of the foam, corresponding to the deformation perpendicular to the punch penetration. The stiffness torque and Young's modulus is important for improving puncture resistance. If the polymer film has a Young's modulus of greater than 1.5 GPa but is not sufficiently stiff, the puncture resistance will not improve.

The film has other advantages, notably it allows stabilizing the multilayer structure by providing it with greater rigidity and also allows to maintain good creep strength.

The film also allows a homogenized expansion of the foam, which can be directly coated on the film, as opposed to an expansion on a glass mesh having an uneven surface. In this configuration, the backing of the foam layer is perfectly smooth and optionally enables a decoration to be printed with a good finish.

Advantageously the polymer film has a thickness of greater than 30 μm, and preferably between 50 μm and 250 μm. Under 30 μm the film would be too brittle and above 250 μm handling the film would be difficult, which would lead to an extra production cost.

Advantageously the polymer film has a stiffness of between 100 N/mm and 300 N/mm, and a Young's modulus of between 1.5 GPa and 5 GPa. Under 100 N/mm the stiffness is not sufficient to improve puncture resistance, and above 300 N/mm the film becomes difficult to handle during the manufacturing process of the multilayer structure, in particular when passing over chucks, etc. Under 1.5 GPa it is necessary to use a very thick polymer film in order to obtain a stiffness of greater than 100 N/mm and above 5 GPa it is necessary to use a very thin polymer film in order to obtain a stiffness of less than 300 N/mm.

In particular, the polymer used for the film can be selected from thermoplastic polymers such as polyvinyl chloride (PVC), polyethylene terephthalate (PET), polymethyl methacrylate (PMMA), polyethylene terephthalate glycol (PETG) and polyphenylene sulfide (PPS). The polymer used to create the film (5) can also be selected from thermoset polymers such as epoxy resins, polyesters, polyvinyl esters, phenolic resins, polyimides and cross-linked polyurethanes. However, using thermoset polymers is more complex since they require the use of a complexing process other than thermowelding, for example glueing.

According to a particular embodiment, the polymer film is a film comprising polyvinyl chloride and less than 10% by weight of plasticizer.

According to another embodiment, the film is a polyethylene terephthalate film forming a complex with at least one copolyester layer with a thickness in the micrometer range, positioned on the face of the film intended to be in contact with the polyvinyl chloride foam in order to improve the adhesion of the polymer film to the polyvinyl chloride of the foam.

In a particular way, the polymer film can form a complex with at least one glass mat or a non-woven fabric positioned on the face of the film intended to be in contact with the polyvinyl chloride foam. In this way, it is possible to coat the foam directly on the reverse face of the glass mat or the non-woven fabric and to obtain a true impregnation of the polyvinyl chloride foam and thus to improve the adhesion of the polyvinyl chloride foam to the polymer film.

In order to improve the behavior of the polymer film during the manufacturing process, it can be complexed with at least one reinforcement mesh, such as a glass mesh or a polyester mesh.

The film can be positioned between the wear layer and the polyvinyl chloride foam, or be integrated into the thickness of the wear layer, not being directly in contact with the polyvinyl chloride foam.

### BRIEF DESCRIPTION OF THE FIGURES

Further advantages and features will become more apparent from the following description of the multilayer structure according to the invention, given by way of a non-limiting example and based on the attached drawings, in which:

FIG. 1 is a schematic view in cross-section of a first exemplary embodiment of the multilayer structure according to the invention;

FIG. 2 is a schematic view similar to that of FIG. 1, illustrating a second embodiment of the multilayer structure according to the invention;

FIG. 3 is a schematic view similar to that of FIG. 1, the polymer film being integrated into the thickness of the wear layer;

FIG. 4 is a schematic view similar to that of FIG. 1, the polymer film being complexed between two copolyester layers;

FIG. 5 is a schematic view similar to that of FIG. 1, the polymer film being complexed between two glass mats or non-woven fabrics;

FIG. 6 is a schematic view similar to that of FIG. 1, the polymer film forming a complex with a reinforcement mesh.

### DETAILED DESCRIPTION OF THE INVENTION

The invention relates to a multilayer structure (1) for the creation of a so-called occasional “sports” floor covering in the sense that it enables at least 25% of shocks to be absorbed according to the test defined in the NF EN 14904 standard of June 2006, and so-called “multipurpose” in the sense that it is resistant to traffic, heavy loads and indentation with a residual deformation of less than 0 5 mm and preferably less than 0.1 mm.

The multilayer structure (1) according to the invention can be in any form, particularly in panel, tile, or preferably in roll form.

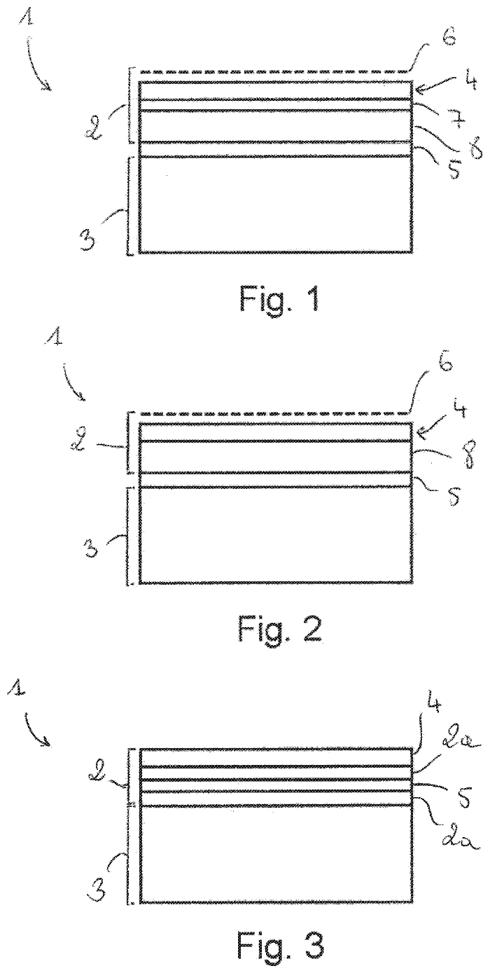

Referring to FIGS. 1 to 6, the multilayer structure (1) comprises an upper wear layer (2), the main functions of which are slip control, resistance to wear, ease of cleaning and the decorative aspect. The wear layer (2) is attached by any suitable technique, such as glueing for example, to a reverse layer (3) made of polyvinyl chloride foam. The foam layer (3) enables the absorption of occasional shocks and is intended to be glued to the floor.

The wear layer (2) comprises at least one surface layer (4) but may also consist of several calendered layers. The wear layer (2) can thus be made up of a calendered layer dyed in the mass, optionally obtained by pressing for a “speckled” decorative effect, a transparent layer, a transparent layer of which the reverse face is attached to a decorative film, a transparent layer of which the reverse face is attached to a print layer.

More generally, the wear layer (2) can be composed of any one of the layers described above, the reverse face of which is attached with one or more calendered folds, as is well known by a person skilled in the art.

The foam layer (3) made of polyvinyl chloride is made from, for example, expanded Plastisol and has a density of between 0.20 and 0.50, preferably between 0.30 and 0.40 in order to comply with the NF EN 14904 standard of June 2006 and absorb at least 25% of occasional shocks.

According to the invention, the multilayer structure (1) comprises a polymer film (5) positioned between the surface layer (4) and the foam layer (3) in order to limit the indentation phenomena of the covering during punching. In other words, the polymer film (5) can be positioned directly between the foam layer (3) and the wear layer (2) (cf. FIGS. 1, 2 and 4 to 6), or the film can be integrated under the surface layer (4) and into the thickness of the wear layer (2), for example between two calendered layers (2a) of the wear layer (2) (cf. FIG. 3), so as to not be in contact with the foam. The polymer film (5) according to the present invention is never positioned on the surface of the multilayer structure (1).

The polymer film (5) limits the indentation phenomena in the foam due to a better stress distribution and a reduction in the shearing effect on the cell walls of the foam, i.e. a reduction in the deformation perpendicular to a punch penetration. The polymer film (5) thus allows the reduction of the maximum plastic deformation of the foam, and the improvement of the springback of the multilayer structure and the absorption of occasional shocks.

The polymer used to create the film (5) can be selected from thermoplastic polymers such as polyvinyl chloride, polyethylene terephthalate, polymethyl methacrylate, polyethylene terephthalate glycol and polyphenylene sulfide. The polymer used to create the film (5) can also be selected from thermoset polymers such as epoxy resins, polyesters, polyvinyl esters, phenolic resins, polyimides and cross-linked polyurethanes. However, the use of thermoset polymers is more complex since it requires the use of a complexing process different from thermowelding, such as glueing.

The polymer film (5) has a thickness of greater than 30 μm, and preferably of between 50 μm and 250 μm. This value range enables the polymer film (5) to have a stiffness of greater than 100 N/mm, and particularly a stiffness of between 100 N/mm and 300 N/mm. A stiffness of greater than 300 N/mm would make the film difficult to handle during the manufacturing process of the multilayer structure (1), namely when passing over chucks, etc.

Stiffness is a concept of elasticity in terms of solid mechanics: stresses and displacements. In geometrically simple cases, these values can be analytically linked.

For example, in the case of an elongated sample with a constant cross-section in tension and compression, the stiffness is expressed based on Young's modulus:
One will say that the stiffness K=(S×E)/(L)
where:
S is the cross-sectional area of the sample;
E is the tensile elastic modulus (Young's modulus);
L is the length of the sample.

The method that enables this stiffness value to be measured in order to find out whether a multilayer structure falls within the scope of protection provided by the claims is described in detail below.

The method used is a tensile test. A rectangular-shaped test piece, 25 mm wide and 190 mm long, is stretched at a constant deformation rate, namely 50 mm/min, by means of a dynamometer until it breaks. The characterization test is built based on the ISO 527-3 standard. Before the tensile test, the test piece is conditioned at 23° C. and 50% humidity for 24 h. The thickness of the test piece is measured under the same temperature conditions, and according to the ISO 24346 standard with the use of a comparator in the air-conditioned room of the dynamometer.

The Applicant used the dynamometer marketed by Lloyd Instruments—AMETEK, LRSK model with pneumatic jaws spaced at 50 mm, and a class 0.5 sensor with a capacity of 5 kN according to the ISO 7500-1 standard.

The stiffness is then calculated by software, specifically Nexygen Plus 3.0 software. The software also enables the Young's Modulus of the test piece to be calculated.

The advantage of the polymer film (5), according to the invention, is that it has a Young's modulus of greater than 1.5 GPa, and preferably of between 1.5 GPa and 5 GPa. The compromise between thickness, stiffness and Young's modulus is important. If the polymer film (5) has a Young's modulus of greater than 1.5 GPa but is not sufficiently stiff, the indentation resistance will only be slightly improved.

The stiffness and rigidity of the polymer film (5) also enable the product to be stabilized and the creep strength thereof to be maintained.

Since the polymer film (5) enables the maximum plastic deformation of the foam to be reduced, it therefore enables the density of the foam to be reduced while still being compliant in creep strength.

Indeed, tests have been carried out by the Applicant with a polymer film (5) made of polyethylene terephthalate (PET) having a thickness of 0.125 mm, and with different foam densities.

According to the tests resulting from the table below, the formulation of the plastisol used for the design of the foams remains the same, and only the density of the foam varies. The polymer film (5) is inserted directly between the PVC foam and the reverse face of the wear layer (2). By way of example, the foam used comprises 34% by weight of plasticizer, 8% by weight of filler, 53% by weight of polyvinyl chloride and 5% by weight of other additives.

The table below summarizes the residual deformation values in response to the indentation defined in the standard, and show that the density of the foam can be reduced while allowing equivalent indentation resistance results to be obtained.

| Sample | Foam | Indentation |
|---|---|---|
| number | density | (mm) |
| No. 1 | 0.30 | 0.07 |
| No. 2 | 0.31 | 0.08 |
| No. 3 | 0.33 | 0.06 |
| No. 4 | 0.34 | 0.06 |

By way of non-limiting example, referring to FIG. 1, the multilayer structure (1) comprises:
a wear layer (2) consisting of:
   a transparent surface layer (4) made of PVC having a thickness of between 0.25 mm and 0.75 mm, for example 0.5 mm, comprising 27% by weight of plasticizer, 70% by weight of PVC, 3% by weight of other additives and whereupon a polyurethane varnish (6) is deposited;
   a decorative film (7) made of PVC having a thickness of between 0.05 mm and 0.3 mm, for example 0.15 mm, attached to the reverse face of the surface layer (4);
   a reverse layer (8) made of calendered PVC having a thickness of between 0.5 mm and 1.5 mm, for example 0.8 mm, comprising 17% by weight of plasticizer, 43% by weight of filler, 39% by weight of PVC and 1% by weight of other additives;
a polymer film (5) (see table below);
a foam layer (3) made of plasticized PVC having a thickness of between 1 mm and 1 cm, for example 4.2 mm, between 30 and 38% by weight of plasticizer, between 6% and 10% by weight of filler, between 40% and 60% by weight of PVC and between 4% and 6% by weight of other additives.

Several types of polymer film (5) have been tested and the results have been collated in the following table:

| | Young's | Stiff- | Thick- | Indenta- | |
|---|---|---|---|---|---|
| | modulus | ness | ness | tion | Indenta- |
| Support | (GPa) | (N/mm) | (mm) | (mm) | tion |
| Non-woven | 2.34 | 169.0 | 0.200 | 0.20-0.25 | Standard |
| polyester + glass | | | | | |
| mesh (REF) | | | | | |
| PVC film | 1.39 | 97.1 | 0.150 | 0.20-0.25 | Standard |
| Non-stabilized | 4.03 | 100.6 | 0.050 | 0.08 | Good |
| PET | | | | | |
| Non-stabilized | 3.88 | 145.4 | 0.075 | 0.10 | Good |
| PET | | | | | |
| Stabilized PET | 3.31 | 206.7 | 0.125 | 0.07 | Good |
| Non-stabilized | 3.35 | 209.4 | 0.125 | 0.07 | Good |
| PET | | | | | |
| PMMA | 1.78 | 214.1 | 0.250 | 0.07 | Good |
| PPS | 3.10 | 157.0 | 0.100 | 0.08 | Good |
| Rigid PVC | 2.44 | 265.2 | 0.210-0.230 | 0.09 | Good |

Note:
in the example implementing a rigid PVC film as a polymer film (5), rigid PVC is understood as a PVC film comprising less than 10% by weight of plasticizer. A PET film is considered stabilized if it has undergone a thermal treatment to relieve the stress induced during the manufacture thereof by flat die plate extrusion followed by bi-oriented stretching.

The table below shows that the best results in terms of indentation resistance are obtained with a stabilized polyethylene terephthalate (PET) film having a thickness of 0.125 mm, with a polymethyl methacrylate (PMMA) film having a thickness of 0.250 mm, or with a polyphenylene sulfide (PPS) film having a thickness of 0.1 mm.

According to a second example shown in FIG. 2, the multilayer structure (1) comprises:
a wear layer (2) consisting of:
   a transparent surface layer (4) made of PVC having a thickness of between 0.25 mm and 0.75 mm, with a graining and whereupon a polyurethane varnish (6) is deposited;
   a reverse layer (8) made of calendered PVC having a thickness of between 0.5 mm and 1.5 mm;
a polymer film (5) (see table above);
a foam layer (3) made of plasticized PVC having a thickness of between 1 mm and 1 cm.

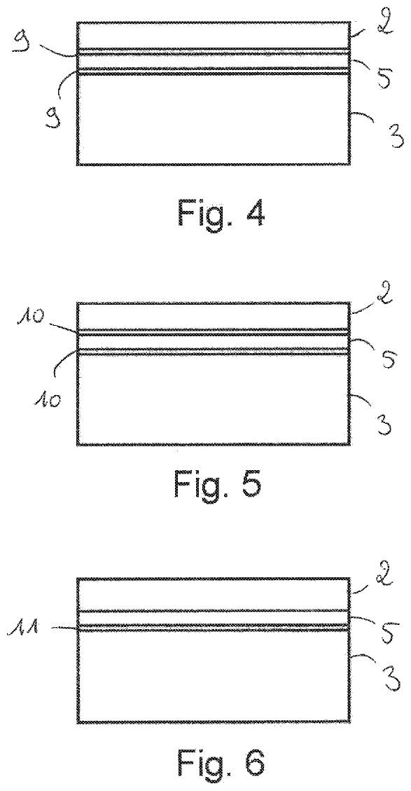

In practice, and referring to FIG. 4, during the manufacture of the multilayer structure (1) according to the invention, if the polymer film (5) used is a PET film, and the same is inserted between the reverse face of the wear layer (2) and the foam, the PET film is preferably complexed between two copolyester layers (9) in order to improve the adhesion between the PET film and the PVC of the foam and the reverse of the wear layer (2). The copolyester layers (9) have a thickness of between 1 μm and 10 μm with a preferred working temperature to achieve the strongest possible adhesion. To further improve the adhesion of the copolyester (9) to the PVC foam, a person skilled in the art will know to adjust the thickness of the copolyester layers (9) or even the formulation of the same, in order to come closer to the optimal bonding conditions vis-à-vis the coating process of the foam layer (3).

Particularly, and in order to facilitate the bonding of the foam on the polymer film (5), it is also possible to attach the backing of the polymer film (5) to a glass mat or a non-woven fabric (10) whereupon the foam layer (3) is directly coated. This allows a true impregnation of the foam on the non-woven support to be obtained. The polymer film (5) can be complexed between two glass mats or non-woven fabrics (10).

Alternatively, referring to FIG. 3, and in order to prevent adhesion problems between the PVC foam and the PET film, said film is preferably inserted into the thickness of the wear layer (2) between two calendered layers (2a). Therefore, the PET film is hot-melt bonded in one of the calendered layers or the reverse thereof.

Referring to FIG. 6, and in order to improve the behavior of the polymer film (5) when it is handled in the manufacturing process of the multilayer structure (1), the polymer film (5) forms a complex with at least one reinforcement mesh (11).

For example, the polymer film (5) is complexed with a glass mesh with a PVAC binder. The glass mesh has, for example, a weight of 34.5 g/m² and a thickness of 0.145 mm. Another example consists of complexing the polymer film (5) with a polyester mesh with an ethylene vinyl acetate (EVA) binder. The polyester mesh has, for example, a weight of 45 g/m² and a thickness of 0.22 mm.

In light of the foregoing, the invention provides a multilayer structure (1) for the creation of a multipurpose sports floor covering, enabling at least 25% of occasional shocks to be absorbed, while being resistant to traffic, heavy loads and indentations, with a deformation of less than 0.1 mm according to the test defined in the standard.

What is claimed is:

1. A multilayer structure (1) for the creation of a multipurpose sports floor covering, said multilayer structure (1) comprising an upper wear layer (2) composed of at least one surface layer (4), the wear layer (2) being attached to a reverse layer (3) made of polyvinyl chloride foam, characterized in that it comprises a polymer film (5), positioned between the surface layer (4) and the reverse layer (3), and having a stiffness of greater than 100 N/mm and a Young's modulus of greater than 1.5 GPa.

2. A multilayer structure (1) according to claim 1, characterized in that the polymer film (5) has a thickness of greater than 30 μm.

3. A multilayer structure (1) according to claim 2, characterized in that the polymer film (5) has a thickness of between 50 μm and 250 μm.

4. A multilayer structure (1) according to claim 1, characterized in that the polymer film (5) has a stiffness of between 100 N/mm and 300 N/mm.

5. A multilayer structure (1) according to claim 1, characterized in that the polymer film (5) has a Young's modulus of between 1.5 GPa and 5 GPa.

6. A multilayer structure (1) according to claim 1, characterized in that the polymer is a thermoplastic polymer selected from polyvinyl chloride, polyethylene terephthalate, polymethyl methacrylate, polyethylene terephthalate glycol and polyphenylene sulfide.

7. A multilayer structure (1) according to claim 6, characterized in that the polymer film (5) comprises polyvinyl chloride and less than 10% by weight of plasticizer.

8. A multilayer structure (1) according to claim 6, characterized in that the polymer film (5) is a polyethylene terephthalate film and forms a complex with at least one copolyester layer (9) positioned on the face of the film (5) intended to be in contact with the reverse layer (3) made of polyvinyl chloride foam.

9. A multilayer structure (1) according to claim 1, characterized in that the polymer film (5) forms a complex with at least one glass mat or a non-woven fabric (10) positioned on the face of the film (5) intended to be in contact with the reverse layer (3) made of polyvinyl chloride foam.

10. A multilayer structure (1) according to claim 1, characterized in that the polymer film (5) forms a complex with at least one reinforcement mesh (11).

11. A multilayer structure (1) according to claim 1, characterized in that the polymer film (5) is integrated into the thickness of the wear layer (2).
